(19) United States
(12) Patent Application Publication
(10) Pub. No.: US 2022/0231912 A1
(43) Pub. Date: Jul. 21, 2022

(54) NETWORK CONFIGURATION OPTIMIZATION USING A REINFORCEMENT LEARNING AGENT

(71) Applicant: Telefonaktiebolaget LM Ericsson (publ), Stockholm (SE)

(72) Inventors: Jaeseong JEONG, Solna (SE); Mattias LIDSTRÖM, Stockholm (SE)

(73) Assignee: Telefonaktiebolaget LM Ericsson (publ), Stockholm (SE)

(21) Appl. No.: 17/605,139

(22) PCT Filed: Apr. 23, 2019
(86) PCT No.: PCT/EP2019/060302

§ 371 Date: Oct. 20, 2021

(51) Int. Cl. H04L 41/0823; G06N 3/08; G06N 3/04; H04L 41/14; H04L 41/16

(52) U.S. Cl. CPC H04L 41/0823; G06N 3/08; H04L 41/16; H04L 41/145; G06N 3/0454

(57) ABSTRACT

A calibrator is employed to adjust the output of a network simulator that functions to simulate an operational network, such that the adjusted output better matches reality. The calibrator is a machine learning system. For example, the calibrator may be the generative model of a GAN.

### TECHNICAL FIELD

Disclosed are embodiments related to using a reinforcement learning agent to optimize a network configuration.

### BACKGROUND

1. Mobile Networks

Mobile network operators (MNOs) must design their network's architecture to balance the requirements of, for example, capacity, coverage, and quality of service (QoS) against cost of deployment and maintenance. Network planning phases include traffic forecasting, dimensioning, expansion planning, and redundancy needs estimation to correctly gauge these requirements. This phase also includes static initial setting of many radio access network (RAN) parameters.

Once a mobile network is up and running, it will still need constant network optimization (tuning) to evolve with user needs and usage change patterns.

Current RANs have evolved architecturally to what is called C-RAN (cloud-RAN or centralized RAN). A simplified C-RAN architecture is illustrated in FIG. 1. This network design comprises radio units (RUs) split from the baseband processing (BB) units (called the Digital Units (DUs)). This allows more flexibility with a centralized or distributed deployment depending on network planning and design constraints. For example, an RU 102 may be located remotely from its corresponding DU 104, or an RU 103 may be co-located with its correspond DU 105. As shown in FIG. 1, the RUs are connected to an antenna arrangement (e.g., RU 103 is connected to antenna arrangement 108), and the DUs are connected to a core network 110.

The DUs (programmed directly or via Operations Support System (OSS)) control hundreds of RAN parameters. As MNOs evolve towards 5G networks, the number of parameters to optimize will increase by factors of tens or hundreds. Network heterogeneity and coexistence with non-licensed bands will make network planning and optimization extremely difficult. This is one of the reasons behind new research and development trends using machine learning (e.g., deep learning techniques) to optimize resources in these networks.

2. Example RAN Parameters

There are many RAN parameters configured during network planning and later optimized. Example RAN parameters include antenna tilt, transmit power, antenna azimuth, etc. One of the most basic configurations during network planning, and in the near future, in real-time network optimization (or Self-Organizing Networks (SON)), comprises optimally tilting the antenna in the right angle to optimize coverage, throughput, and power consumption. It is to be noted that although tilt optimization is the example parameter used to describe the methods in this document, the disclosed methods may alternatively or additionally be applied to any other network parameter (e.g., transmit power, antenna azimuth, etc.)

Tilting an antenna is performed by mechanical means or by electrical tilt. Tilting affects the cell edge (e.g., tilting down will shrink the cell). Tilting affects throughput, coverage, and power usage. Moreover, uplink (UL) traffic is mostly affected by tilt. The Remote Electrical Tilt (RET) is controlled by the DU, which itself is controlled via direct configuration or via OSS. It is to be noted that not all radio unit models support RET, which should be considered during network planning phases. Currently, RET takes about 5 seconds to stabilize making hourly tilt optimization frequency possible. Most of the tilt configuration today is done statically.

3. Machine Learning

3.1 Reinforcement Learning (RL)

Reinforcement Learning (RL) is a rapidly evolving machine learning (ML) technology that enables an RL agent to initiate real-time adjustments to a system, while continuously training the RL agent using a feedback loop. The skilled person will be familiar with RL and RL agents, nevertheless the following provides a brief introduction to RL agents.

Reinforcement learning is a type of machine learning process whereby an RL agent (e.g., a programmed computer) is used to select an action to be performed on a system based on information indicating a current state of the system (or part of the system). For example, based on current state information obtained from the system an objective, the RL agent can initiate an action (e.g., an adjustment of a parameter, such as, for example, antenna tilt, signal power, horizontal beam width, precoder, etc.) to be performed on the system, which may, for example, comprise adjusting the system towards an optimal or preferred state of the system. The RL agent receives a “reward” based on whether the action changes the system in compliance with the objective (e.g., towards the preferred state), or against the objective (e.g., further away from the preferred state). The RL agent therefore adjusts parameters in the system with the goal of maximizing the rewards received.

Use of an RL agent allows decisions to be updated (e.g., through learning and updating a model associated with the RL agent) dynamically as the environment changes, based on previous decisions (or actions) performed by the RL agent. Put more formally, an RL agent receives an observation from the environment (denoted St) and selects an action (denoted At) to maximize the expected future reward. Based on the expected future rewards, a value function for each state can be calculated and an optimal policy that maximizes the long term value function can be derived.

Recent works, such as reference [1] (reference citations listed at the end of the document), highlight the possibilities and challenges with using big data technique for network optimization in general. Large amounts of RAN data are available: eNB configuration information, resource status, interference, handover/mobility, signalling messages, and of course, radio signal measurements. More recent publications (e.g., reference [2]) survey existing works using specifically RL in mobile network optimization. They conclude that this area remains mainly unexplored and that network optimizations similar to Google DeepMind's achievements are possible (e.g., 40% reduction in data center cooling of reference [3]). Reference [4] presents an RL-based optimization of high volume non-real time traffic scheduling for Internet of Things (IoT) wireless use cases. Reference [5] used RL to show that the technique can replace domain experts (usually required for heuristics and search strategies) to solve a problem of radio frequency selection.

3.2 Generative Adversarial Networks (GANs)

A Generative adversarial network (GAN) is a machine learning system that employs two neural networks that compete against each other in a zero-sum or minimax game. One neural network is a generative model (denoted G), and the other neural network (denoted D) is a discriminative model. G captures the data distribution and D estimates the probability that the sample came from the training data rather than G (see Reference [6]).

As stated in reference [6], this can be thought of as a counterfeiter model (G) that tries fake a painting and a discriminative model (D) that tries to detect the fake. After the training, the result would be a picture produced by G that is almost indistinguishable from the target data—a perfect fake.

A GAN has been used to do image to image translation (see reference [7]). Many problems in image processing can be thought of as translation—for example changing an image from night to day, or drawing a complex scene based on a rough sketch. A GAN has also been used to produce a complex coverage map from a rough sketch (see reference [9]).

### SUMMARY

Certain challenges exist. For example, a challenging issue with respect to using an RL agent in a network is how to train the RL agent. RL agents learn from interactive exploration through many random actions to an operational network. For network operators, it is very hard to allow such training to take place when the RL agent is deployed in the operational network, as those random explorations cause significant degradation of service quality.

One strategy, therefore, is to train the RL agent using a simulated network, and then deploy the trained RL agent in the real network. Training the RL agent in this manner means running a simulation to collect reward and next state at each iteration step t for a given action. As running simulations is much cheaper than trials in reality, this strategy of training the RL agent using a network simulator that functions to simulate an operational network is advantageous, provided, however, that the output from the network simulator (i.e., reward R′t and next state S′t+1) is equal to (or close to) the output from reality (i.e., reward Rt and next state St+1). However, there is usually a gap between simulation and reality.

This disclosure, therefore, provides a technique to close the gap between the simulated network and reality. More specifically, a calibrator is employed to adjust the output of the network simulator such that the adjusted output better matches reality. The calibrator is a machine learning system. For example, the calibrator may be the generative model of a GAN.

An advantage of calibrating the output of the network simulator is that the output will more closely match reality, which will, in turn, improve the training of the RL agent. Moreover, this technique does not require any changes to the existing network simulator.

Accordingly, in one aspect there is provided a method for optimizing a network configuration for an operational network using a reinforcement learning agent. The method includes training a machine learning system using a training dataset that comprises i) simulated information produced by a network simulator simulating the operational network and ii) observed information obtained from the operational network. The method also includes, after training the machine learning system, using the network simulator to produce first simulated information based on initial state information and a first action selected by the reinforcement learning agent. The method further includes using the machine learning system to produce second simulated information based on the first simulated information produced by the network simulator. The method also includes training the reinforcement learning agent using the second simulated information, wherein training the reinforcement learning agent using the second simulated information comprises the reinforcement learning agent selecting a second action based on the second simulated information produced by the machine learning system.

In another aspect there is provided a system for training a reinforcement learning agent. The system includes a network simulator; a machine learning system; and a reinforcement learning (RL) agent. The network simulator is configured to produce first simulated information based on initial state information and a first action selected by the RL agent. The machine learning system is configured to produce second simulated information based on the first simulated information produced by the network simulator. And the RL agent is configured to select a second action based on the second simulated information produced by the machine learning system.

### BRIEF DESCRIPTION OF THE DRAWINGS

The accompanying drawings, which are incorporated herein and form part of the specification, illustrate various embodiments.

FIG. 1 illustrates a mobile network according to an embodiment.

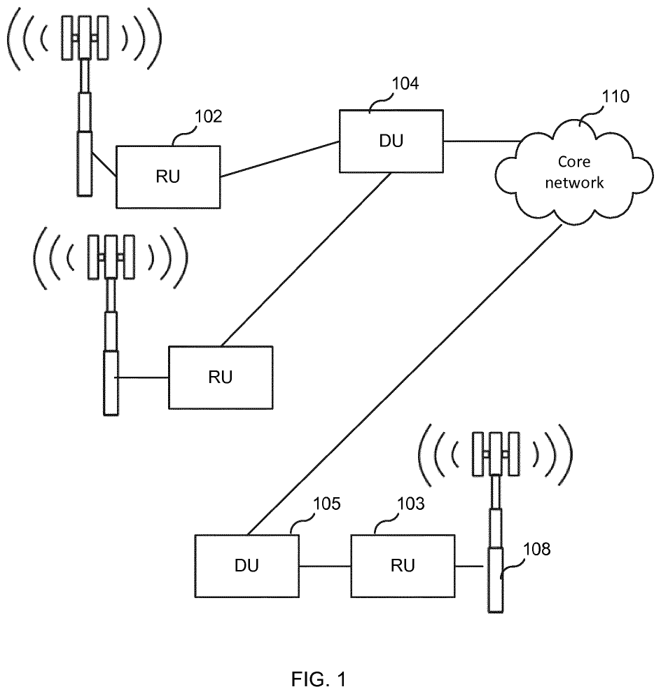

FIG. 2 illustrates a system for training an RL agent according to an embodiment.

FIG. 3 illustrates the deployment of an RL agent according to an embodiment.

FIG. 4 illustrates a policy network according to an embodiment.

FIG. 5 illustrates a system according to an embodiment.

FIG. 6 illustrates a training process according to an embodiment.

FIG. 7 is a flow chart illustrating a process according to an embodiment.

FIG. 8 is a block diagram illustrating an apparatus according to an embodiment.

FIG. 9 is a schematic block diagram of an apparatus according to an embodiment.

### DETAILED DESCRIPTION

1. Training Phase Using Simulated Environment

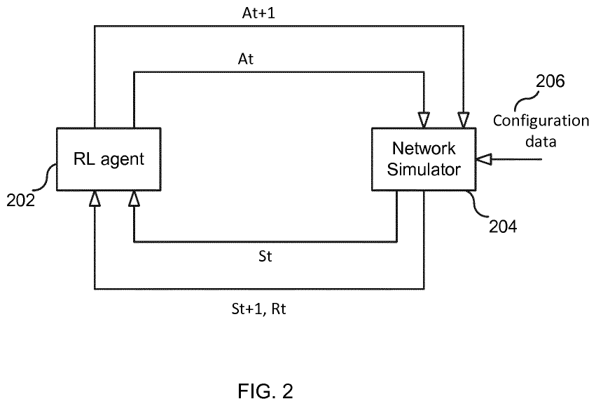

As noted above, it is advantageous to train an RL agent using a network simulator that simulates an operational network. This is illustrated in FIG. 2, which shows an RL agent 202 obtaining from a network simulator 204 simulated information (e.g., St, St+1, Rt). In one embodiment the network simulator can take as initial input 206 configuration data, which may include: a map of the city and buildings in the region of interest; information regarding the locations where antennas are deployed; information indicating the frequency bands in which each antenna operates; information indicating network traffic density, etc. Network simulator 204 then produces at time t simulated state information (denoted St) indicating a simulated state of the operational network. RL agent 202 receives St and then selects an action (At) (e.g., tilt a selected antenna by a selected amount). Information indicating At is then input into network simulator 204, which then produces, at time t+1 and based on At, simulated state information (St+1) and a simulated reward information (denoted Rt) corresponding to At (e.g., information indicating average user throughput; average Received Signal Strength Indicator (RSSI); etc.). At the next iteration, RL agent 202 receives St+1 and Rt and selects another action At+1, which is then input into network simulator 204, which then produces St+2 and Rt+1 corresponding to At+1. At the next iteration, RL agent 202 receives St+2 and Rt+1 and selects another action At+2, which is then input into network simulator 204, which then produces St+3 and Rt+2 corresponding to At+2. This process continues for many cycles until RL agent 202, after which RL agent 202 will be adept at selecting an action that produces a good reward (e.g., increased average user throughput).

2. Real World Environment

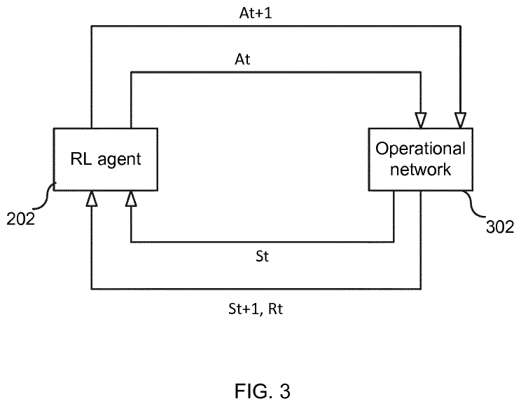

Once RL agent 202 is trained on the simulated environment, RL agent 202 deployed into the operational network 302 (see FIG. 3). FIG. 3 depicts the trained RL agent 202 and interaction with the real world environment. A Markov Decision Problem (MDP) optimization objective could be selected depending on operator policy. For example, throughput is a valid objective for the simulation phase. In case of network planning, the objective could be to optimize overall throughput at termination of the simulation. For adaptive optimization, the throughput could be optimized for the sum of throughput over time.

In case of real world deployment, RSSI may be a more valid objective function to optimize. It is to be noted that for simplicity, this document primarily refers to throughput.

3. The RL Policy Network

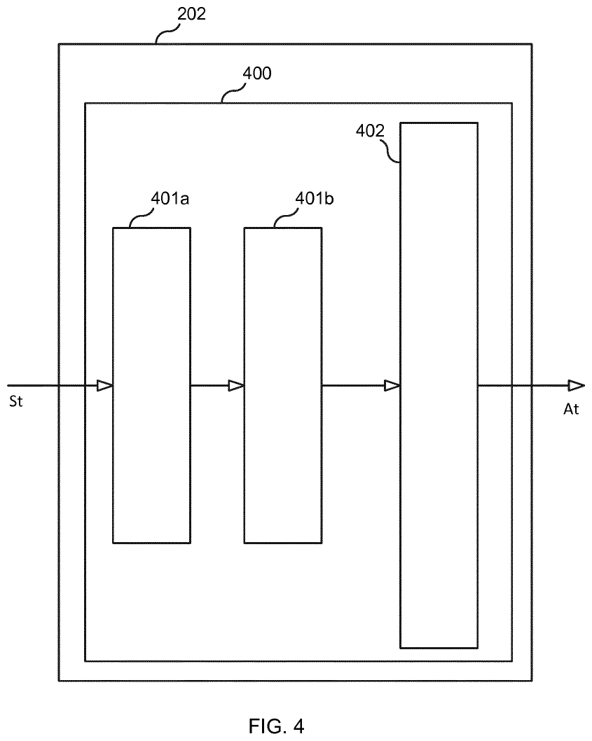

FIG. 4 illustrates RL agent 202 according to one embodiment. This is a non-limiting example implementation and other RL implementations are possible. As shown in FIG. 4, RL agent 202 may be implemented using a convolutional neural network (CNN) 400 that includes a stack of distinct layers that transform the input (e.g., St) into an output (e.g., At). In the example, shown, CNN 400 includes a first convolutional layer 401a connected to a second convolutional layer 401b connected to a fully connected layer 402. As is known in the art, convolutional layers 401a,b are used for the efficient processing of high dimensional input state matrices (e.g. St) and the fully connected layer 402, among other things, calculates the probability distribution of actions, thereby enablin the selection of action (e.g., At).

4. Improving the Training Procedure

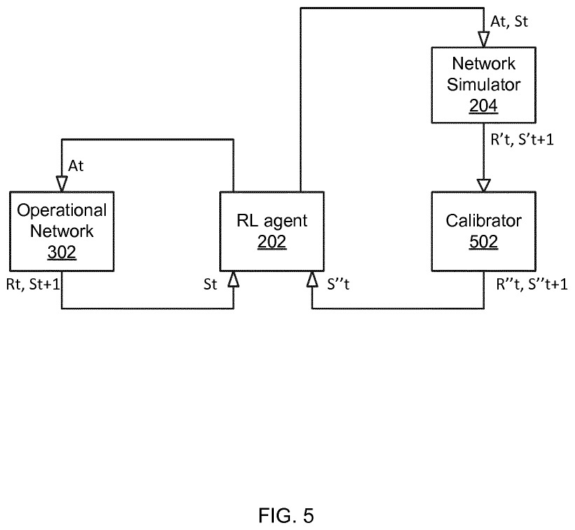

As mentioned above, there is usually a gap between simulation and reality. That is, the simulated information produced by network simulator 204 may be a poor representation of reality. This disclosure, therefore, provides a technique to close the gap between the simulated information and reality. More specifically, as shown in FIG. 5, a calibrator 502 is employed to adjust the output of the network simulator 204 (e.g., S′t+1 and R′t) such that the adjusted output (e.g., S″t+1 and R″t) better matches reality (St+1 and Rt). The calibrator 502 is a machine learning system. For example, the calibrator may be the generative model of a GAN.

As the calibrator 502 (e.g., generative model) is trained by data collected from the real world, the calibrator 502 can work after the agent 202 is transferred to the operational network (real environment) and collects the data samples (St, Rt, St+1) from the operational network. In other words, the calibrator 502 is trained by the feedback data from the operational network. After the calibrator 502 is trained, the output of the calibrator 502 (e.g., S″t+1, R″t) will be closer to the observed state and reward information from the operational network (St+1, Rt), and thereby, an agent trained using the calibrated data will work much better in the operational network 302.

There have been several studies for engaging generative models in virtual environment (see e.g., reference [10]) (i.e., model-based reinforcement learning), where the task of those models is predicting future reward (and state) based on the current state space, whose level of difficulty is usually high. The solution described here, however, lightens the difficulty by keeping and utilizing the network simulator. Feeding the output of simulator as an input to the GAN model, we can use the GAN model as a calibrator in which input and output have an equal data structure (reward and state).

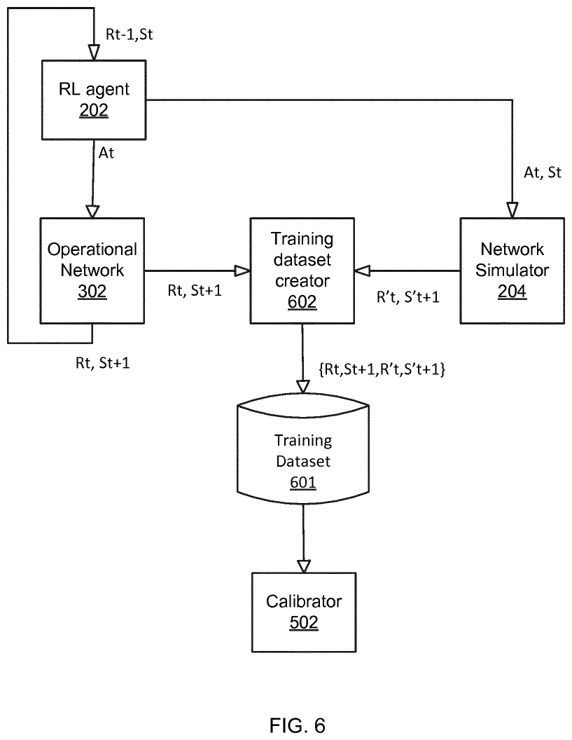

FIG. 6 illustrates a training procedure for training the calibrator 502. Agent 202 is deployed in the operational network 302 and periodically collects from the operational network 302 data (e.g., state information indicating a state of the network 302 at time t (St)), selects an action based on the collected data (e.g., selects an action At based on St), implements the action in network 302 (e.g., adjusts the tile of an antenna), and delivers to simulator 504 the collected data (e.g. St) and information identifying the selected action (At) (e.g., information specifying the antenna tilt action). The network simulator 204 then generates a simulator configuration using St and At, and runs the configured simulator to produce simulated information—i.e., reward R′t and next state S′t+1. This information (R′t and S′t+1) is provided to a training dataset creator 602, which may be a component of network simulator 204 or may be a separate component. Training dataset creator 602 also obtains from network 302 (or from agent 202) observed state and reward information (i.e., St+1, Rt). Training dataset creator 602 then adds to training dataset 601 for training the calibrator 502 a new training record—i.e., (R′t, S′t+1, Rt, St+1), wherein the tuple R′t and S′t+1 are input label and the tuple Rt and St+1 is the output label. Calibrator 502 is then trained using the training dataset 601 so that the calibrator 502 will learn how to map simulated information (R′t, S′t+1) to improved simulated information (R″t, S″t+1) that more closely matches reality (i.e., Rt, St+1). This above process repeats such that training dataset 601 will include numerous training records of the form: (R′t+x, S′t+x+1, Rt+x, St+x+1), where x=0, 1, 2, 3, etc. For example, after (R′t, S′t+1, Rt, St+1) is added to dataset 601, the next record that is added to dataset 601 is: (R′t+1, S′t+2, Rt+1, St+2).

RL agent training with the network simulator and the training of the generative model based calibrator 502 can be parallelized along with the reinforcement learning environment, for instance, using RAY RLlib (see reference [11]) on any cloud platform. This means that the solution will scale with available computation resources. All calibrated states in parallel training threads are collected in order to update the RL agent.

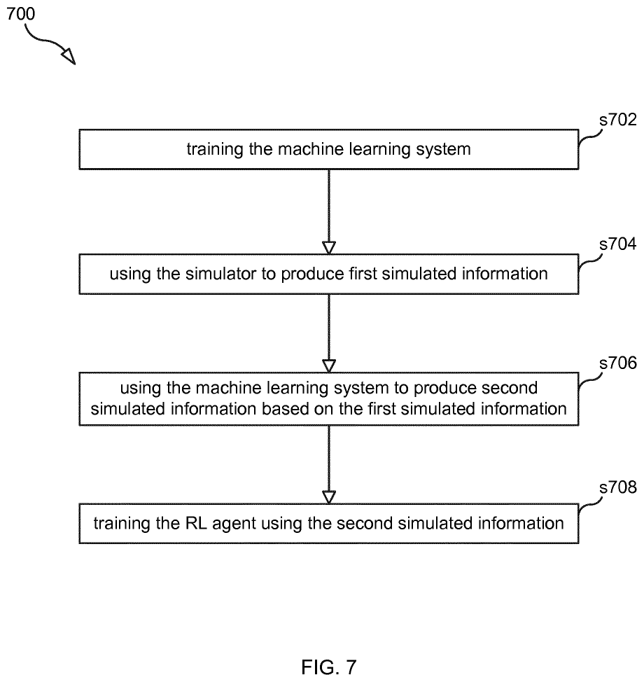

FIG. 7 is a flowchart illustrating a process 700, according to an embodiment, for optimizing a network configuration for operational network 302 using RL agent 202. Process 700 may begin with step s702.

Step s702 comprises training a machine learning system 502 (a.k.a., calibrator 502) using a training dataset that comprises i) simulated information produced by a network simulator 204 simulating the operational network 302 and ii) observed information obtained from the operational network. In some embodiments, the machine learning system is a generative model (e.g., a generative adversarial network (GAN) model).

Step s704 comprises, after training the machine learning system, using the network simulator to produce first simulated information based on initial state information and a first action selected by the RL agent. In some embodiments, the first simulated information comprises first simulated state information (e.g., S′t+1) representing a state of the operational network at a particular point in time (e.g., t+1) and first reward information.

Step s706 comprises using the machine learning system to produce second simulated information based on the first simulated information produced by the network simulator. For example, the second simulated information comprises second simulated state information (e.g., S″t+1), based on the first simulated state information (S′t+1), representing the state of the operational network at the same particular point in time (i.e., t+1) and second reward information (e.g., R″t).

Step s708 comprises training the RL agent using the second simulated information, wherein training the RL agent using the second simulated information comprises using the RL agent to select a second action based on the second simulated information produced by the machine learning system.

In some embodiments, process 700 further includes optimizing a configuration of the operational network, wherein optimizing the configuration comprises using the RL agent to select an action based on currently observed state information indicating a current state of the operational network and applying the third action in the operational network; and after optimizing the configuration, obtaining reward information corresponding to the third action and obtaining new observed state information indicating a new current state of the operational network. In some embodiments, the operational network is a radio access network (RAN) that comprises a baseband unit connected to a radio unit connected to an antenna apparatus. In some embodiments, applying the selected third action comprises modifying a parameter of the RAN (e.g., altering a tile of the antenna apparatus).

In some embodiments, process 700 further includes generating the training dataset, wherein generating the training dataset comprises: obtaining from the operational network first observed state information (St); performing an action on the operational network (At); obtaining first simulated state information (S′t+1) and first simulated reward information (R′t) based on the first observed state information (St) and information indicating the performed action (At); after performing the action, obtaining from the operational network second observed state information (St+1) and observed reward information (Rt); and adding to the training dataset a four-tuple consisting of: R′t, S′t+1, Rt, and St+1.

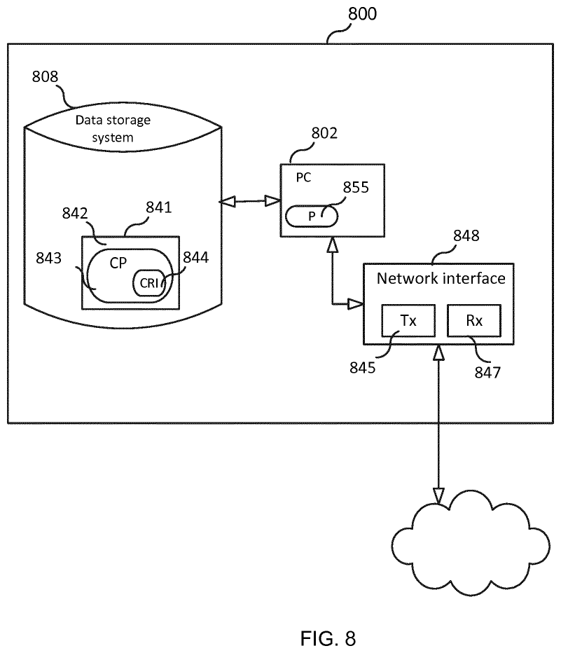

FIG. 8 is a block diagram of an apparatus 800, according to some embodiments, that can be used to implement any one of RL agent 202, network simulator 204, calibrator 502, dataset creator 602. As shown in FIG. 8, apparatus 800 may comprise: processing circuitry (PC) 802, which may include one or more processors (P) 855 (e.g., one or more general purpose microprocessors and/or one or more other processors, such as an application specific integrated circuit (ASIC), field-programmable gate arrays (FPGAs), and the like) which processors 855 may be co-located in a single housing or in a single data center or may be geographically distributed (i.e., apparatus 800 may be a distributed computing apparatus); a network interface 848, which comprises a transmitter (Tx) 845 and a receiver (Rx) 847, for enabling apparatus 800 to transmit data to and receive data from other nodes connected to the network to which network interface 848 is connected; and a local storage unit (a.k.a., “data storage system”) 808, which may include one or more non-volatile storage devices and/or one or more volatile storage devices. In embodiments where PC 802 includes a programmable processor, a computer program product (CPP) 841 may be provided. CPP 841 includes a computer readable medium (CRM) 842 storing a computer program (CP) 843 comprising computer readable instructions (CRI) 844. CRM 842 may be a non-transitory computer readable medium, such as, magnetic media (e.g., a hard disk), optical media, memory devices (e.g., random access memory, flash memory), and the like. In some embodiments, the CRI 844 of computer program 843 is configured such that when executed by PC 802, the CRI causes apparatus 800 to perform steps described herein (e.g., steps described herein with reference to the flow charts). In other embodiments, apparatus 800 may be configured to perform steps described herein without the need for code. That is, for example, PC 802 may consist merely of one or more ASICs. Hence, the features of the embodiments described herein may be implemented in hardware and/or software.

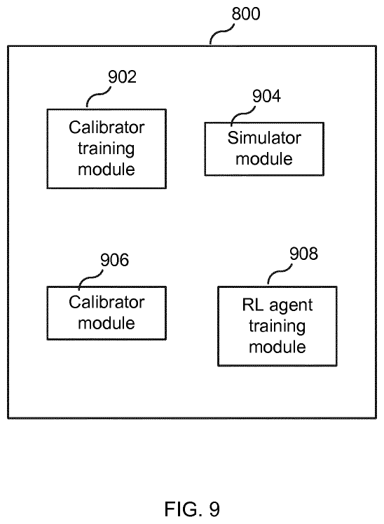

FIG. 9 is a schematic block diagram of apparatus 800 according to some other embodiments. The apparatus 800 includes one or more modules, each of which is implemented in software. The module(s) provide the functionality of apparatus 800 described herein (e.g., the steps herein, e.g., with respect to FIG. 7). In one embodiment, the modules include: a calibrator training module 902 configured to train the calibrator 502; a simulator module 904 configured to produce simulated information (e.g., S′t, S′t+1, etc.); a calibrator module 906 configured to produce simulated information based on the simulated information produced by the simulator module 904 (e.g., S″t, S″t+1, etc.); and an RL agent training module 908 configured to train the RL agent using the simulated information produced by the calibrator module 906.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### REFERENCES

[1] Zheng, K., Yang, Z., Zhang, K., Chatzimisios, P., Yang, K. and Xiang, W., 2016. Big data-driven optimization for mobile networks toward 5G. IEEE network, 30(1), pp. 44-51. [Available at http://shop.tarjomeplus.com/Uploads/site-1/DownloadDoc/1240.pdf];
[2] Zhang, C., Patras, P. and Haddadi, H., 2018. Deep Learning in Mobile and Wireless Networking: A Survey. arXiv preprint arXiv:1803.04311. [Available at https://arxiv.org/pdf/1803.04311.pdf];
[3] Evans, R. and Gao, J., 2016. DeepMind AI Reduces Google Data Centre Cooling Bill by 40% [Available at https://deepmind.com/blog/deepmind-ai-reduces-google-data-centre-cooling-bill-40/];
[4] Chinchali, S., Hu, P., Chu, T., Sharma, M., Bansal, M., Misra, R., Pavone, M. and Sachin, K., 2018. Cellular network traffic scheduling with deep reinforcement learning. In National Conference on Artificial Intelligence (AAAI). [Available at https://asl.stanford.edu/wp-content/papercite-data/pdf/Chinchali.ea.AAAI18.pdf];
[5] O'Shea, T. J. and Clancy, T. C., 2016. Deep reinforcement learning radio control and signal detection with KeRLym, a Gym RL agent. arXiv preprint arXiv:1605.09221. [Available at https://arxiv.org/pdf/1605.09221.pdf];
[6] Ian J. Goodfellow, et. al, “Generative Adversial Nets”, https://arxiv.org/pdf/1406.2661.pdf;
[7] Phillip Isola, Jun-Yan Zhu, Tinghui Zhou, Alexei A. Efros, “Image-to-Image Translation with Conditional Adversarial Networks”, arXiv 2016;
[8] Brock, Andrew, Jeff Donahue, and Karen Simonyan. “Large Scale GAN Training for High Fidelity Natural Image Synthesis.” arXiv preprint arXiv:1809.11096 (2018);
[9] PCT/EP2017/083581 (docket no. P72519 W01), “A method for drawing a radio coverage map with generative machine learning models,” filed on Dec. 19, 201;
[10] Buesing, Lars, et al. “Learning and Querying Fast Generative Models for Reinforcement Learning.” arXiv preprint arXiv:1802.03006 (2018);
[11] RAY RLlib, https://ray.readthedocs.io/en/latest/rllib.html.

1. A method for optimizing a network configuration for an operational network using a reinforcement learning agent, the method comprising:
training a machine learning system using a training dataset that comprises i) simulated information produced by a network simulator simulating the operational network and ii) observed information obtained from the operational network;
after training the machine learning system, using the network simulator to produce first simulated information based on initial state information and a first action selected by the reinforcement learning agent;
using the machine learning system to produce second simulated information based on the first simulated information produced by the network simulator; and
training the reinforcement learning agent using the second simulated information, wherein training the reinforcement learning agent using the second simulated information comprises using the reinforcement learning agent to select a second action based on the second simulated information produced by the machine learning system.

2. The method of claim 1, wherein the machine learning system is a generative model.

3. The method of claim 2, wherein the generative model is a generative adversarial network (GAN) model.

4. The method of claim 1, wherein
the first simulated information comprises: i) first simulated state information representing a state of the operational network at a particular point in time and ii) first reward information, and
the second simulated information comprises: i) second simulated state information representing the state of the operational network at said particular point in time and ii) second reward information.

5. The method of claim 1, further comprising:
optimizing a configuration of the operational network, wherein optimizing the configuration comprises using the reinforcement learning agent to select an action based on currently observed state information indicating a current state of the operational network and applying the third action in the operational network; and
after optimizing the configuration, obtaining reward information corresponding to the third action and obtaining new observed state information indicating a new current state of the operational network.

6. The method of claim 5, wherein the operational network is a radio access network (RAN) that comprises a baseband unit connected to a radio unit connected to an antenna apparatus.

7. The method of claim 6, wherein applying the selected third action comprises modifying a parameter of the RAN.

8. The method of claim 1, further comprising generating the training dataset, wherein generating the training dataset comprises:
obtaining from the operational network first observed state information (St);
performing an action on the operational network (At);
obtaining first simulated state information (S′t+1) and first simulated reward information (R′t) based on the first observed state information (St) and information indicating the performed action (At);
after performing the action, obtaining from the operational network second observed state information (St+1) and observed reward information (Rt); and
adding to the training dataset a four-tuple consisting of: R′t, S′t+1, Rt, and St+1.

9. A system for training a reinforcement learning agent, the system comprising:
a network simulator;
a machine learning system; and
a reinforcement learning (RL) agent, wherein
the network simulator is configured to produce first simulated information based on initial state information and a first action selected by the RL agent; and
the machine learning system is configured to produce second simulated information based on the first simulated information produced by the network simulator; and
the RL agent is configured to select a second action based on the second simulated information produced by the machine learning system.

10. The system of claim 9, wherein the machine learning system is a generative model.

11. The system of claim 10, wherein the generative model is a generative adversarial network (GAN) model.

12. The system of claim 9, wherein
the first simulated information comprises first simulated state information representing a state of the operational network at a particular point in time and first reward information, and
the second simulated information comprises second simulated state information representing the state of the operational network at said particular point in time and second reward information.

13. The system of claim 9, wherein
the RL agent is configured to optimize a configuration of an operational network by selecting an action based on currently observed state information indicating a current state of the operational network and applying the third action in the operational network; and
the RL agent is further configured to, after optimizing the configuration, obtain reward information corresponding to the third action and obtain new observed state information indicating a new current state of the operational network.

14. The system of claim 13, wherein the operational network is a radio access network (RAN) that comprises a baseband unit connected to a radio unit connected to an antenna apparatus.

15. The system of claim 14, wherein applying the selected third action comprises modifying a parameter of the RAN.

16. The system of any one of claim 9, further comprising a training dataset creator for creating a training dataset.

17. The system of claim 16, wherein the training dataset creator is configured to:
obtain simulated state information (S′t+1) and simulated reward information (R′t) produced by the network simulator;
obtain observed state information (St+1) and observed reward information (Rt); and
add to the training dataset a four-tuple consisting of: R′t, S′t+1, Rt, and St+1.
